(19) United States
(12) Patent Application Publication
(10) Pub. No.: US 2022/0161788 A1
(43) Pub. Date: May 26, 2022

(54) DRIVING SUPPORT DEVICE OF SADDLE-RIDING TYPE VEHICLE

(71) Applicant: HONDA MOTOR CO., LTD., Minato-ku, Tokyo (JP)

(72) Inventors: Tsutomu Tamashima, Wako-shi (JP); Tsubasa Nose, Wako-shi (JP); Kiyotaka Sakai, Wako-shi (JP); Hiroaki Uchisasai, Wako-shi (JP); Yuta Kanbe, Wako-shi (JP)

(21) Appl. No.: 17/598,312

(22) PCT Filed: Mar. 29, 2019
(86) PCT No.: PCT/JP2019/014049

§ 371 Date: Sep. 27, 2021

(51) Int. Cl. B60W 30/09; B60W 30/095; B60W 30/16; B60W 10/20; B60W 40/04

(52) U.S. Cl. CPC B60W 30/09; B60W 30/0956; B60W 30/16; B60W 2554/404; B60W 40/04; B60W 2300/36; B60W 2552/00; B60W 10/20

(57) ABSTRACT

This driving support device of a saddle-riding type vehicle includes: an external detection means (29) that detects a situation around the vehicle; a steering device (ST) that steers an own vehicle; and a control means (27) that controls drive of the steering device (ST), wherein the control means (27) operates the steering device (ST) according to the situation around the vehicle detected by the external detection means (29) regardless of an operation of a rider (J) and moves a traveling trajectory in a lane width direction within a lane in which the own vehicle is traveling.

### TECHNICAL FIELD

The present invention relates to a driving support device of a saddle-riding type vehicle.

### BACKGROUND ART

For example, Patent Document 1 discloses a control device for providing highly responsive driving support without impairing the driving feeling of a saddle-riding type vehicle. This control device includes a prediction unit and a vehicle control unit. The prediction unit determines the intention of a rider to turn the vehicle based on at least one of predetermined pre-turn behavior of a vehicle body and a driving operation of the rider and predicts the occurrence of the vehicle turn. The vehicle control unit provides driving support when the vehicle turns based on the prediction result of the prediction unit.

### RELATED ART DOCUMENT

### Patent Document

Patent Document 1: PCT International Publication No. WO2018/216308

### SUMMARY

### Problems to be Solved by the Invention

Incidentally, the above-described related art does not disclose the positioning of the saddle-riding type vehicle within the same lane in a lane width direction. That is, since the saddle-riding type vehicle such as a motorcycle has a smaller vehicle body than that of a passenger car, it is conceivable that the position of the saddle-riding type vehicle in the lane width direction may change even if a traveling lane (a lane) of the saddle-riding type vehicle is the same as that of the passenger car. For example, it is conceivable that a trajectory is changed to the inside or outside of a corner within the same lane during cornering, or that the vehicles are alternately shifted in the lane width direction and arranged in a zigzag shape during group driving. Therefore, a configuration suitable for such a situation is required.

Therefore, the present invention provides a driving support device of a saddle-riding type vehicle which can appropriately position the saddle-riding type vehicle in the lane width direction within the same lane.

### Means for Solving the Problem

As a means for solving the above-described problems, a first aspect of the present invention includes: an external detection means (29) that detects a situation around a vehicle; a steering device (ST) that steers an own vehicle; and a control means (27) that controls drive of the steering device (ST), wherein the control means (27) operates the steering device (ST) according to the situation around the vehicle detected by the external detection means (29) regardless of an operation of a rider (J) and moves a traveling trajectory in a lane width direction within a lane in which the own vehicle is traveling.

According to this configuration, when driving support control such as following traveling control or lane maintaining support is performed, it is possible to change the position of the own vehicle in the lane width direction within the same traveling lane according to the situation around the vehicle detected by the external detection means. For this reason, in the driving support control, for example, it is possible for the rider to unconsciously correct the traveling trajectory of the own vehicle within the same lane during cornering, or it is possible to arrange the vehicles in a zigzag shape by alternately shifting the vehicles in the lane width direction during group driving, and thus it is possible to enhance the commercial value of the driving support device.

According to a second aspect of the present invention, in the above-described first aspect, when the external detection means (29) detects a corner in a traveling direction of the own vehicle, the control means (27) operates the steering device (ST) and moves the traveling trajectory to an outside of the corner within the lane in which the own vehicle is traveling.

According to this configuration, it is possible to change the traveling trajectory of the own vehicle to the outside of the corner within the same traveling lane according to the corner in front of the vehicle detected by the external detection means. As a result, it is possible to assist the own vehicle to be located on the outer side when entering the corner, to improve the visibility of the corner, to reduce the fatigue of the driver, and to direct cornering using the lane width.

According to a third aspect of the present invention, in the above-described first or second aspect, when the external detection means (29) detects that the own vehicle enters a corner, the control means (27) operates the steering device (ST) and moves the traveling trajectory toward a center in the lane width direction within the lane in which the own vehicle is traveling.

According to this configuration, it is possible to move the traveling trajectory from the outside of the corner to the center side of the lane width during the cornering of the own vehicle. As a result, after the own vehicle enters the corner from the outer side, the traveling trajectory is moved to the inside of the corner (the center side), and it is possible to direct cornering using the lane width.

According to a fourth aspect of the present invention, in any one of the above-described first to third aspects, when the external detection means (29) detects a corner exit in a traveling direction of the own vehicle, the control means (27) operates the steering device (ST) and moves the traveling trajectory to an outside of the corner within the lane in which the own vehicle is traveling.

According to this configuration, when the own vehicle reaches the corner exit, it is possible to move the traveling trajectory from the center side of the lane width to the outside of the corner. Therefore, it is possible to direct cornering in which the own vehicle accelerates at the corner exit and is biased to the outer side.

According to a fifth aspect of the present invention, in any one of the above-described first to fourth aspects, when the external detection means (29) detects approach of a following vehicle (1B) from behind the vehicle, the control means (27) operates the steering device (ST) and moves the traveling trajectory to a shoulder side within the lane in which the own vehicle is traveling.

According to this configuration, when the approach of the following vehicle is detected, the own vehicle is moved to the shoulder side within the traveling lane, and thus the own vehicle is easily passed by the approaching following vehicle. As a result, it is possible to enhance the commercial value of the driving support device.

According to a sixth aspect of the present invention, in any one of the above-described first to fifth aspects, the control means (27) has a control mode in which, when following traveling is performed while maintaining an inter-vehicle distance with a preceding vehicle (1A), the traveling trajectory is shifted with respect to the preceding vehicle (1A) in the lane width direction within the lane in which the own vehicle is traveling.

According to this configuration, when the following traveling is performed with respect to the preceding vehicle, it is possible not only to perform the following traveling at a position directly behind the preceding vehicle but also to perform the following traveling at a position shifted with respect to the preceding vehicle in the lane width direction. Therefore, for example, when a plurality of vehicles are traveling in a group, it is possible to assist with the so-called zigzag traveling in which the vehicles are alternately shifted and arranged in the lane width direction, and thus it is possible to enhance the commercial value of the driving support device.

### ADVANTAGE OF THE INVENTION

According to the present invention, it is possible to provide a driving support device of a saddle-riding type vehicle which can appropriately position the saddle-riding type vehicle in the lane width direction within the same lane.

### BRIEF DESCRIPTION OF THE DRAWINGS

FIG. 1 is a configuration diagram of a vehicle system according to an embodiment of the present invention.

FIG. 2 is an explanatory view showing how a recognition unit of the vehicle system recognizes the relative position and posture of an own vehicle with respect to a traveling lane.

FIG. 3 is an explanatory diagram showing how a target trajectory is generated based on a recommended lane in the vehicle system.

FIG. 4 is a left side view of a motorcycle according to the embodiment.

FIG. 5 is a configuration diagram of a control device of the motorcycle.

FIG. 6 is a configuration diagram of a driving support device of the motorcycle.

FIG. 7 is an explanatory view of the motorcycle from above.

FIG. 8 is an explanatory view showing a first example of driving support control of the motorcycle.

FIG. 9 is an explanatory view showing a second example of driving support control of the motorcycle.

FIG. 10 shows explanatory views of a third example of driving support control of the motorcycle in the order of (a) and (b).

FIG. 11 is an explanatory view showing a fourth example of driving support control of the motorcycle.

FIG. 12 is an explanatory view showing a fifth example of driving support control of the motorcycle.

FIG. 13 shows explanatory views of a sixth example of driving support control of the motorcycle, where (a) shows a comparative example and (b) shows the sixth example.

FIG. 14 is an explanatory view showing a seventh example of driving support control of the motorcycle.

### DESCRIPTION OF THE EMBODIMENTS

Hereinafter, an example of a vehicle system of the present embodiment will be described with reference to the drawings.

In the present embodiment, it is assumed that the vehicle system is applied to an automatic driving vehicle. Here, there is a degree of automatic driving. The degree of automatic driving can be determined by, for example, a scale such as whether it is less than a predetermined reference or is equal to or more than a predetermined reference. A case in which the degree of automatic driving is less than a predetermined reference is, for example, a case in which manual driving is being executed or a case in which only a driving support device such as an adaptive cruise control system (ACC) or a lane keeping assistance system (LKAS) is operating. A driving mode in which the degree of automatic driving is less than a predetermined reference is an example of a “first driving mode.” Further, a case in which the degree of automatic driving is equal to or more than a predetermined reference is, for example, a case in which a driving support device such as auto lane changing (ALC) or low speed car passing (LSP), which has a higher degree of control than the ACC or LKAS, is operating or a case in which automatic driving for automatically performing lane change, merging, and branching is being executed. A driving mode in which the degree of automatic driving is equal to or more than a predetermined reference is an example of a “second driving mode.” This predetermined reference can be set arbitrarily. In the embodiment, it is assumed that the first driving mode is manual driving and the second driving mode is automatic driving.

<Whole system>

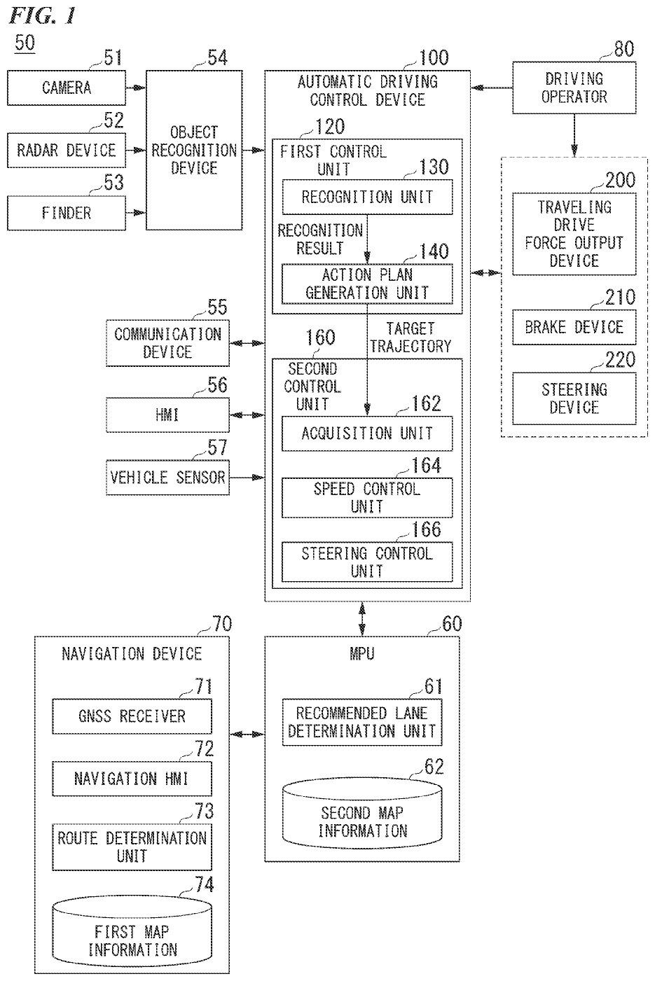

FIG. 1 is a configuration diagram of a vehicle system 50 according to the embodiment. The vehicle in which the vehicle system 50 is equipped is, for example, a vehicle such as a two-wheeled vehicle, a three-wheeled vehicle, or a four-wheeled vehicle, and the drive source thereof is an internal combustion engine such as a gasoline engine or a diesel engine, an electric motor, or a combination thereof. The electric motor operates using the electric power generated by a generator connected to an internal combustion engine or the electric power discharged from a secondary battery or a fuel cell.

The vehicle system 50 includes, for example, a camera 51, a radar device 52, a finder 53, an object recognition device 54, a communication device 55, a human machine interface (HMI) 56, a vehicle sensor 57, a navigation device 70, a map positioning unit (MPU) 60, a driving operator 80, an automatic driving control device 100, a traveling drive force output device 200, a brake device 210, and a steering device 220. These devices and instruments are connected to each other by a multiplex communication line such as a controller area network (CAN) communication line, a serial communication line, a wireless communication network, or the like. The configuration shown in FIG. 1 is merely an example, and some of the configuration may be omitted or another configuration may be added.

The camera 51 is, for example, a digital camera that uses a solid-state image sensor such as a charge coupled device (CCD) or a complementary metal oxide semiconductor (CMOS). The camera 51 is attached to an arbitrary position on the vehicle (hereinafter referred to as an own vehicle M) in which the vehicle system 50 is equipped. In a case in which the front is photographed, the camera 51 is attached to the upper portion of a front windshield, the back surface of a rearview mirror, and the like. In a case of a saddle-riding type vehicle such as a two-wheeled vehicle, the camera 51 is attached to a steering system component, an exterior component on a vehicle body side on which the steering system component is supported, or the like. The camera 51 periodically and repeatedly images the periphery of the own vehicle M, for example. The camera 51 may be a stereo camera.

The radar device 52 radiates radio waves such as millimeter waves near the own vehicle M and detects the radio waves (reflected waves) reflected by an object to detect at least the position (the distance and direction) of the object. The radar device 52 is attached to an arbitrary position of the own vehicle M. The radar device 52 may detect the position and speed of the object by a frequency modulated continuous wave (FM-CW) method.

The finder 53 is a light detection and ranging (LIDAR). The finder 53 irradiates the periphery of the own vehicle M with light and measures scattered light. The finder 53 detects the distance to the target based on the time from light emission to light reception. The emitted light is, for example, a pulsed laser beam. The finder 53 is attached to an arbitrary position of the own vehicle M.

The object recognition device 54 performs sensor fusion processing on the detection results of some or all of the camera 51, the radar device 52, and the finder 53 and recognizes the position, type, speed, and the like of the object. The object recognition device 54 outputs the recognition result to the automatic driving control device 100. The object recognition device 54 may output the detection results of the camera 51, the radar device 52, and the finder 53 to the automatic driving control device 100 as they are. The object recognition device 54 may be omitted from the vehicle system 50.

The communication device 55 communicates with another vehicle near the own vehicle M using, for example, a cellular network, a Wi-Fi network, Bluetooth (registered trademark), dedicated short range communication (DSRC), and the like or communicates with various server devices via a radio base station.

The HMI 56 presents various items of information to the occupant of the own vehicle M and accepts input operations performed by the occupant. The HMI 56 includes various display devices, a speaker, a buzzer, a touch panel, switches, keys, and the like.

The vehicle sensor 57 includes a vehicle speed sensor that detects the speed of the own vehicle M, an acceleration sensor that detects the acceleration, a yaw rate sensor that detects the angular speed around the vertical axis, a direction sensor that detects the direction of the own vehicle M, and the like.

The navigation device 70 includes, for example, a global navigation satellite system (GNSS) receiver 71, a navigation HMI 72, and a route determination unit 73. The navigation device 70 holds first map information 74 in a storage device such as a hard disk drive (HDD) or a flash memory. The GNSS receiver 71 identifies the position of the own vehicle M based on a signal received from a GNSS satellite. The position of the own vehicle M may be identified or complemented by an inertial navigation system (INS) using the output of the vehicle sensor 57. The navigation HMI 72 includes a display device, a speaker, a touch panel, keys, and the like. The navigation HMI 72 may be partially or wholly shared with the above-mentioned HMI 56. For example, the route determination unit 73 determines a route from the position of the own vehicle M (or an input arbitrary position) identified by the GNSS receiver 71 to the destination input by the occupant using the navigation HMI 72 (hereinafter referred to as a route on a map) with reference to the first map information 74. The first map information 74 is, for example, information in which a road shape is expressed by a link indicating a road and nodes connected by the link. The first map information 74 may include road curvature, point of interest (POI) information, and the like. The route on the map is output to the MPU 60. The navigation device 70 may perform route guidance using the navigation HMI 72 based on the route on the map. The navigation device 70 may be realized by, for example, the function of a terminal device such as a smartphone or a tablet terminal owned by the occupant. The navigation device 70 may transmit the current position and the destination to the navigation server via the communication device 55 and may acquire a route equivalent to the route on the map from the navigation server.

The MPU 60 includes, for example, a recommended lane determination unit 61 and holds second map information 62 in a storage device such as an HDD or a flash memory. The recommended lane determination unit 61 divides the route on the map provided by the navigation device 70 into a plurality of blocks (for example, divides the route every 100 [m] in a vehicle traveling direction), refers to the second map information 62, and determines the recommended lane for each block. The recommended lane determination unit 61 determines which lane from the left to drive in. In a case in which a branch point exists on the route on the map, the recommended lane determination unit 61 determines the recommended lane such that the own vehicle M can travel on a reasonable route to travel to the branch destination.

The second map information 62 is more accurate map information than the first map information 74. The second map information 62 includes, for example, information on the center of the lane, information on the boundary of the lane, and the like. Further, the second map information 62 may include road information, traffic regulation information, address information (address/zip code), facility information, telephone number information, and the like. The second map information 62 may be updated at any time by the communication device 55 communicating with another device.

The driving operator 80 includes, for example, an accelerator pedal (and a grip), a brake pedal (and a lever), a shift lever (and a pedal), a steering wheel (and a bar handle), a different type of steering device, a joystick, and other operators. A sensor for detecting the amount of operation or the presence or absence of the operation is attached to the driving operator 80, and the detection result is output to some or all of the automatic driving control device 100, the traveling drive force output device 200, the brake device 210, and the steering device 220.

The automatic driving control device 100 includes, for example, a first control unit 120 and a second control unit 160. The first control unit 120 and the second control unit 160 are realized by, for example, a hardware processor such as a central processing unit (CPU) executing a program (software). In addition, some or all of these components may be realized by hardware (a circuit unit: including circuitry) such as a large scale integration (LSI), an application specific integrated circuit (ASIC), a field-programmable gate array (FPGA), and a graphics processing unit (GPU) or may be realized by software and hardware in cooperation.

The first control unit 120 includes, for example, a recognition unit 130 and an action plan generation unit 140. The first control unit 120 realizes, for example, a function by artificial intelligence (AI) and a function by a model given in advance in parallel. For example, the function of “recognizing an intersection” may be realized by executing the recognition of an intersection by deep learning or the like and the recognition based on conditions given in advance (there are signals that can be pattern matched, road markings, and the like) in parallel, or may be realized by scoring and comprehensively evaluating both recognitions. This ensures the reliability of automatic driving.

The recognition unit 130 recognizes the position, the speed, and the acceleration of an object (another vehicle, or the like) near the own vehicle M based on the information input from the camera 51, the radar device 52, and the finder 53 via the object recognition device 54. The position of the object is recognized as, for example, a position on absolute coordinates with a representative point (the center of gravity, the center of a drive axis, or the like) of the own vehicle M as the origin and is used for control. The position of the object may be represented by a representative point such as the center of gravity or a corner of the object, or may be represented by a represented area. The “state” of the object may include the acceleration, the jerk, or the “behavioral state” of the object (for example, whether or not the vehicle is changing lanes, or is about to change lanes).

Further, the recognition unit 130 recognizes, for example, the lane (the traveling lane) in which the own vehicle M is traveling. For example, the recognition unit 130 recognizes the traveling lane by comparing a pattern of a road marking line (for example, an arrangement of a solid line and a broken line) obtained from the second map information 62 and a pattern of a road marking line near the own vehicle M recognized from the image captured by the camera 51. The recognition unit 130 may recognize the traveling lane by recognizing the traveling road boundary (the road boundary) including the road marking line, the road shoulder, the curb, the median strip, the guardrail, and the like, as well as the road marking line. In this recognition, the position of the own vehicle M acquired from the navigation device 70 and the processing result by the INS may be taken into account. The recognition unit 130 also recognizes a stop line, an obstacle, a red light, a tollgate, and other road events.

When recognizing the traveling lane, the recognition unit 130 recognizes the position and posture of the own vehicle M with respect to the traveling lane.

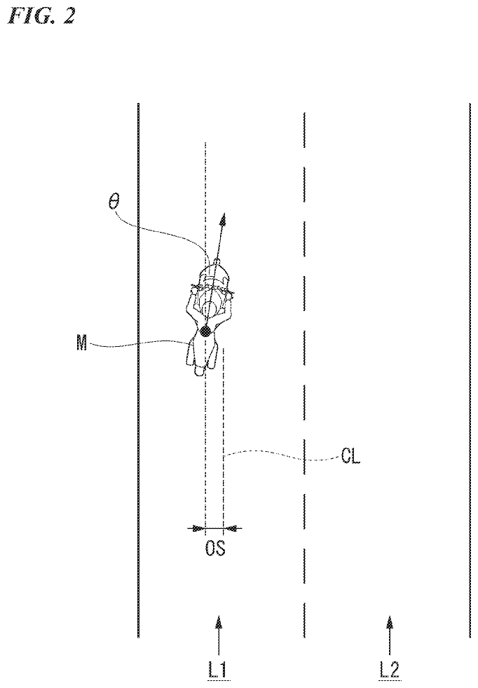

FIG. 2 is a view showing an example of how the recognition unit 130 recognizes the relative position and posture of an own vehicle M with respect to a traveling lane L1. The recognition unit 130 may recognize, for example, a deviation OS of the reference point (for example, the center of gravity) of the own vehicle M from the center CL of the traveling lane and an angle θ formed by the traveling direction of the own vehicle M and a line along the center CL of the traveling lane as the relative position and posture of the own vehicle M with respect to the traveling lane L1. Alternatively, the recognition unit 130 may recognize the position or the like of the reference point of the own vehicle M with respect to any side end portion (the road marking line or the road boundary) of the traveling lane L1 as a relative position of the own vehicle M with respect to the traveling lane.

Returning to FIG. 1, the action plan generation unit 140, in principle, travels in the recommended lane determined by the recommended lane determination unit 61 and generates a target trajectory to travel forward automatically (regardless of the driver's operation) to be able to respond to the surrounding conditions of the own vehicle M. The target trajectory includes, for example, a speed element. For example, the target trajectory is expressed as a sequence of points (trajectory points) to be reached by the own vehicle M. The trajectory points are points to be reached by the own vehicle M for each predetermined traveling distance (for example, about several [m]) along the road, and apart from that, a target speed and a target acceleration for each predetermined sampling time (for example, about several tenths of a [sec]) are generated as part of the target trajectory. Further, the trajectory point may be a position to be reached by the own vehicle M at the sampling time for each predetermined sampling time. In this case, the information of the target speed and the target acceleration is expressed by the interval of the trajectory point.

The action plan generation unit 140 may set an event for automatic driving when generating the target trajectory. The event for automatic driving includes, for example, a constant speed traveling event in which the own vehicle travels in the same traveling lane at a constant speed, a following traveling event in which the own vehicle travels behind a preceding vehicle, a lane change event in which the own vehicle M changes the traveling lane, a branching event in which the own vehicle M travels in a desired direction at a branching point of the road, a merging event in which the own vehicle M merges at a merging point, and a passing event in which the own vehicle M passes the preceding vehicle. The action plan generation unit 140 generates a target trajectory according to the activated event.

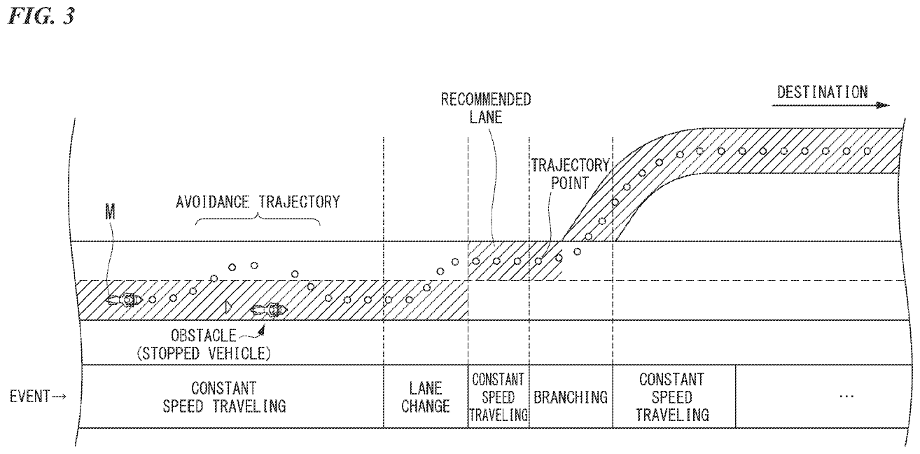

FIG. 3 is a diagram showing how the target trajectory is generated based on the recommended lane. As shown, the recommended lane is set to be convenient for traveling along the route to the destination. When the own vehicle comes within a predetermined distance of a switching point for the recommended lane (which may be determined according to the type of event), the action plan generation unit 140 activates the lane change event, the branching event, the merging event, and the like. In a case in which it becomes necessary to avoid an obstacle during the execution of each event, an avoidance trajectory is generated as shown.

Returning to FIG. 1, the second control unit 160 controls the traveling drive force output device 200, the brake device 210, and the steering device 220 such that the own vehicle M passes the target trajectory generated by the action plan generation unit 140 at the scheduled time.

The second control unit 160 includes, for example, an acquisition unit 162, a speed control unit 164, and a steering control unit 166. The acquisition unit 162 acquires information on the target trajectory (the trajectory point) generated by the action plan generation unit 140 and stores the information in a memory (not shown). The speed control unit 164 controls the traveling drive force output device 200 or the brake device 210 based on the speed element associated with the target trajectory stored in the memory. The steering control unit 166 controls the steering device 220 according to the degree of curving of the target trajectory stored in the memory. The processing of the speed control unit 164 and the steering control unit 166 is realized by, for example, a combination of feedforward control and feedback control. As an example, the steering control unit 166 executes a combination of feedforward control according to the curvature of the road in front of the own vehicle M and feedback control based on the deviation from the target trajectory.

The traveling drive force output device 200 outputs a traveling drive force (torque) for the own vehicle M to travel to drive wheels. The traveling drive force output device 200 includes, for example, a combination of an internal combustion engine, an electric motor, a transmission, and the like, and an electronic control unit (ECU) that controls them. The ECU controls the above configuration according to the information input from the second control unit 160 or the information input from the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to the information input from the second control unit 160 or the information input from the driving operator 80 such that brake torque corresponding to a braking operation is output to each wheel. The brake device 210 may include, as a backup, a mechanism for transmitting the hydraulic pressure generated by the operation of the brake operator included in the driving operator 80 to the cylinder via the master cylinder. The brake device 210 is not limited to the configuration described above and may be an electronically controlled hydraulic brake device that controls an actuator according to the information input from the second control unit 160 and transmits the hydraulic pressure of a master cylinder to the cylinder.

The steering device 220 includes, for example, a steering ECU and an electric motor. The electric motor applies a force to a rack and pinion mechanism to change the direction of a turning wheel, for example. The steering ECU drives the electric motor according to the information input from the second control unit 160 or the information input from the driving operator 80 and changes the direction of the turning wheel.

### <Whole Vehicle>

Next, a motorcycle, which is an example of a saddle-riding type vehicle in the present embodiment, will be described. Front, rear, left, and right directions in the following description are the same as directions in a vehicle described below unless otherwise specified. Further, an arrow FR indicating a forward direction with respect to the vehicle and an arrow UP indicating an upward direction with respect to the vehicle are shown at appropriate places in the drawings used in the following description.

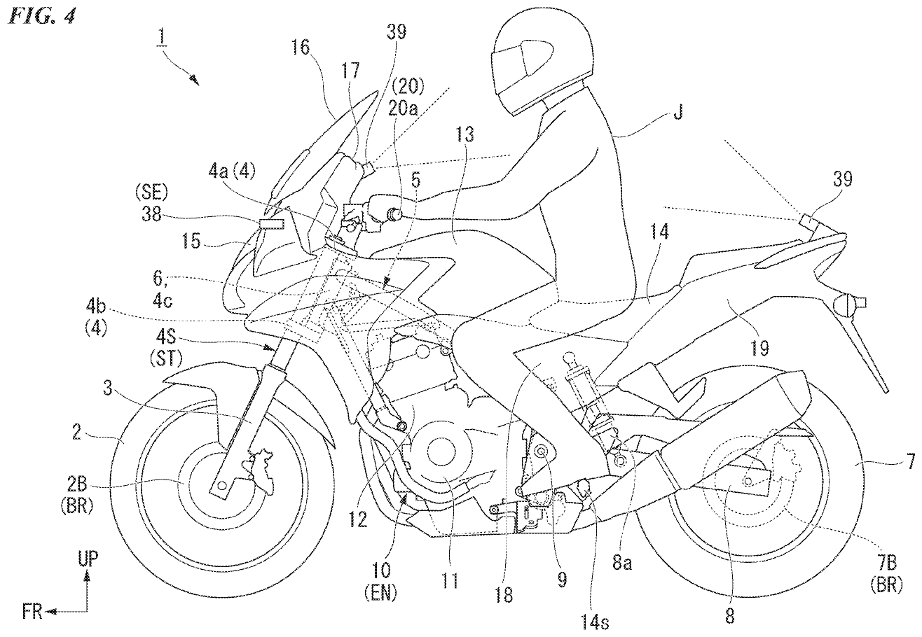

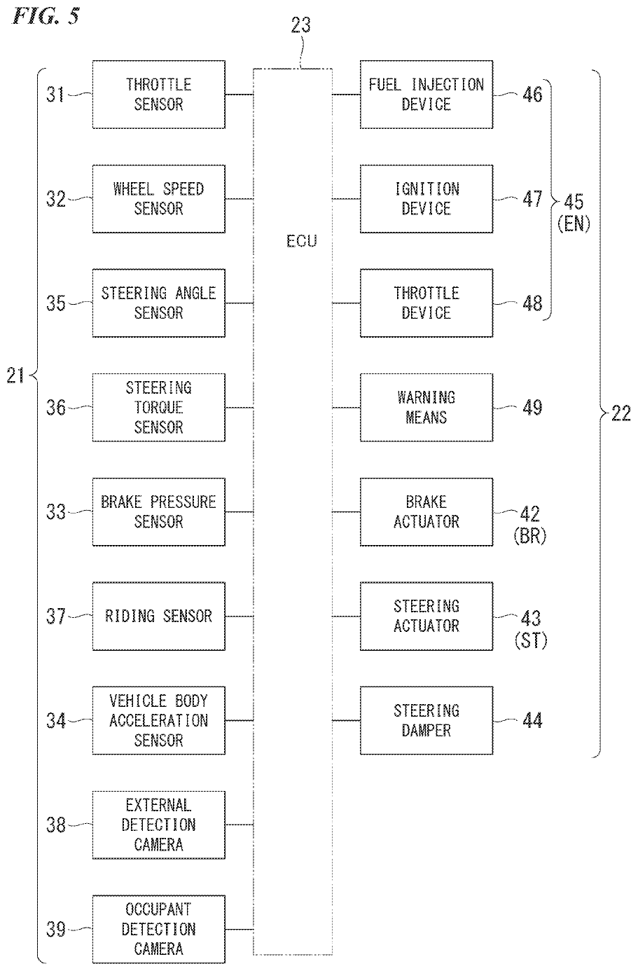

As shown in FIG. 4, a front wheel 2, which is a steering wheel of the motorcycle 1, is supported by the lower ends of a pair of left and right front forks 3. The upper portions of the left and right front forks 3 are supported to be steerable by a head pipe 6 at the front end portion of a vehicle body frame 5 via a steering stem 4. The steering stem 4 includes a steering shaft 4c that is rotatably inserted and supported around the head pipe 6 and upper and lower bridge members (a top bridge 4a and a bottom bridge 4b) that are each fixed to the upper and lower ends of the steering shaft 4c. A bar-type handlebar 20 is attached to at least one of the upper portion (the top bridge 4a) of the steering stem 4 and the left and right front forks 3. The handlebar 20 includes a pair of left and right grips 20a grasped by the rider (the driver) J. In the drawing, reference sign 4S indicates a steering mechanism including the steering stem 4 and the left and right front forks 3, and reference sign ST indicates a steering device including the steering mechanism 4S and a steering actuator 43 (see FIG. 5).

A rear wheel 7, which is a drive wheel of the motorcycle 1, is supported by the rear end portion of a swing arm 8 extending in a front-rear direction on the lower side of a vehicle body rear portion. The front end portion of the swing arm 8 is supported by a pivot portion 9 in the front-rear intermediate portion of the vehicle body frame 5 to be able to swing upward and downward. A rear cushion 8a is disposed between the front portion of the swing arm 8 and the front-rear intermediate portion of the vehicle body frame 5.

An engine (an internal combustion engine) 10, which is a motor, is supported by the vehicle body frame 5. The engine 10 has a cylinder 12 standing upward from the front portion of a crankcase 11. A fuel tank 13 for storing the fuel of the engine 10 is disposed above the engine 10. A seat 14 on which the occupants (driver and rear passengers) sit is disposed behind the fuel tank 13. A pair of left and right steps 14s on which the rider J puts his/her feet are disposed on both the left and right sides below the seat 14. A front cowl 15 supported by the vehicle body frame 5 is attached to the front portion of the vehicle body. A screen 16 is provided above the front portion of the front cowl 15. A meter device 17 is disposed inside the front cowl 15. A side cover 18 is attached to a vehicle body side portion below the seat 14. A rear cowl 19 is attached to the vehicle body rear portion.

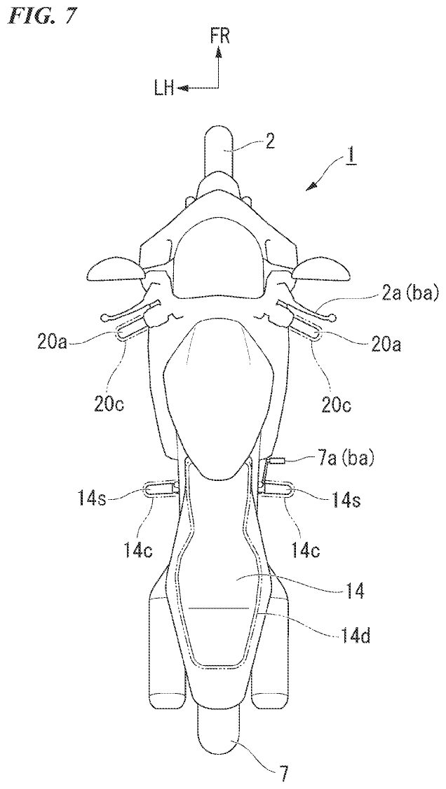

The motorcycle 1 includes a front wheel brake main body 2B, a rear wheel brake main body 7B, and a brake actuator 42 (see FIG. 5). The front wheel brake main body 2B and the rear wheel brake main body 7B are hydraulic disk brakes. The motorcycle 1 configures a by-wire type brake system in which the front wheel brake main body 2B and the rear wheel brake main body 7B are electrically linked with brake operators ba such as a brake lever 2a and a brake pedal 7a (see FIG. 7) which are operated by the rider J. Reference sign BR in the drawing indicates a brake device configured to include the front and rear brake main bodies 2B and 7B and a brake actuator 42.

Here, the brake device BR configures a front and rear interlocked brake system (CBS: combined brake system) that generates a braking force for the front and rear wheels by interlocking the front and rear brake main bodies 2B and 7B, even when one of the brake lever 2a and the brake pedal 7a is operated. Further, the brake device BR configures an antilock brake system (ABS) that appropriately controls the slip ratio of the front and rear wheels by reducing the brake pressure according to the slip state of the front and rear wheels when the front and rear brake main bodies 2B and 7B are operating.

FIG. 5 is a configuration diagram of a main part of the motorcycle 1 according to the present embodiment.

The motorcycle 1 includes a control device 23 that controls the operation of various devices 22 based on detection information acquired from various sensors 21. The control device 23 is configured as, for example, an integral or a plurality of electronic control units (ECUs). At least part of the control device 23 may be realized by software and hardware in cooperation. The control device 23 includes a fuel injection control unit, an ignition control unit, and a throttle control unit that control the operation of the engine 10. The motorcycle 1 configures a by-wire type engine control system in which an auxiliary device such as a throttle device 48 is electrically linked with an accelerator operator such as an accelerator grip operated by the rider J.

The various sensors 21 include a throttle sensor 31, a wheel speed sensor 32, a brake pressure sensor 33, a vehicle body acceleration sensor 34, a steering angle sensor 35, a steering torque sensor 36, a riding sensor 37, an external detection camera 38, and an occupant detection camera 39.

The various sensors 21 detect various operation inputs of the rider J and various states of the motorcycle 1 and the occupant. The various sensors 21 output various items of detection information to the control device 23.

The throttle sensor 31 detects the amount of operation (acceleration request) of the accelerator operator such as the throttle grip.

The wheel speed sensor 32 is provided on each of the front and rear wheels 2 and 7. The detection information of the wheel speed sensor 32 is used for control such as ABS and traction control. The detection information of the wheel speed sensor 32 may be used as vehicle speed information to be transmitted to the meter device 17.

The brake pressure sensor 33 detects the operating force (deceleration request) of the brake operator ba such as the brake lever 2a and the brake pedal 7a.

The vehicle body acceleration sensor 34 is a 5-axis or 6-axis inertial measurement unit (IMU) that detects the angle (or angular speed) and the acceleration of each of the three axes (a roll axis, a pitch axis, and a yaw axis) in the vehicle body. Hereinafter, the vehicle body acceleration sensor 34 may be referred to as an IMU 34.

The steering angle sensor 35 is, for example, a potentiometer provided on the steering shaft 4c and detects the rotation angle (the steering angle) of the steering shaft 4c with respect to the vehicle body.

With reference to FIG. 4, the steering torque sensor 36 is, for example, a magnetic distortion type torque sensor provided between the handlebar 20 and the steering shaft 4c and detects torsional torque (steering input) input from the handlebar 20 to the steering shaft 4c. The steering torque sensor 36 is an example of a load sensor that detects a steering force input to the handlebar 20 (a steering operator).

In the embodiment, a handlebar rotating shaft that rotatably supports the handlebar 20 is the same as the steering shaft 4c that supports the front wheel 2 to be steerable.

Here, for the steering mechanism 4S of the embodiment, a general term for a configuration which is provided between the handlebar 20 and the front wheel 2 (the steering wheel) and transmits the rotation of the handlebar 20 to the front wheel 2 is used. The handlebar rotating shaft and the steering shaft (a front wheel rotating shaft) have the same configuration as each other and may be provided separately from each other or may be provided on different shafts from each other. In a case in which the handlebar rotating shaft and the steering shaft are different shafts from each other, the steering mechanism 4S includes a configuration in which the handlebar rotating shaft and the steering shaft are interlocked with each other.

The riding sensor 37 detects whether or not the rider J is in a normal riding posture. Examples of the riding sensor 37 include a seat sensor 14d which is disposed in the seat 14 and detects the presence or absence of sitting of the rider J, left and right grip sensors 20c which are disposed on left and right grips 20a of the handlebar 20 and detect the presence or absence of the grasp of the rider J, left and right step sensors 14c which are disposed in the left and right steps 14s and detect the presence or absence of the footrest of the rider J, and the like.

With reference to FIG. 7, the grip sensors 20c include a load sensor such as a piezoelectric sensor that detects the magnitude and direction of the load due to the grasp of the rider J, and an acceleration sensor that measures the vibration frequency of the grips 20a. The information detected by the grip sensors 20c is input to the control device 23.

Similarly, the step sensors 14c also include a load sensor that detects the magnitude and direction of the load due to the footrest of the rider J, and an acceleration sensor that measures the vibration frequency of the steps 14s. The information detected by the step sensors 14c is input to the control device 23.

The seat sensor 14d includes a load sensor such as a piezoelectric sensor that detects the magnitude and direction of the load due to the sitting of the rider J. The information detected by the seat sensor 14d is input to the control device 23.

The control device 23 detects that the rider J is in a driving state corresponding to one-handed driving based on a left-right difference in the magnitude of the grasping loads detected by the grip sensors 20c. The “driving state corresponding to one-handed driving” is a state in which the riding posture is not normal and a state in which the posture of the rider J is easily disturbed by the behavior of the vehicle body. When the left-right difference in the magnitude of the grasping loads becomes equal to or greater than a predetermined threshold value, the control device 23 determines that the riding posture of the rider J is not normal. At this time, if automatic control such as automatic braking or automatic steering that causes vehicle body behavior is performed, the posture of the rider J is disturbed, which tends to lead to fatigue. In a case in which the riding posture of the rider J is determined not to be normal, the control device 23 takes measures such as lowering the output of automatic braking and automatic steering. As a result, the disturbance of the posture of the rider J is suppressed.

Further, the control device 23 detects that the rider J is in a driving state corresponding to one-handed driving based on a left-right difference in the grip vibrations detected by the grip sensors 20c. That is, since the relationship between the engine speed and the grip vibration frequency differs depending on whether or not the grip 20a is grasped, one-handed driving can be detected based on the left-right difference in the grip vibrations.

By using the grip load and the vibration frequency, it is possible to accurately detect that the rider J is in a driving state corresponding to one-handed driving.

Here, even if the rider J grasps the left and right grips 20a, for example, in a state in which the rider J is looking back or extending his/her limbs, it is said that the rider J is not in a normal driving posture as in the one-handed driving. The control device 23 detects not only the magnitude of the grasping loads detected by the grip sensors 20c but also the direction of the grasping loads. That is, even in a case in which the direction of the grasping loads changes due to the rider J twisting his/her body or the like, or even in a case in which the direction of the grasping loads changes due to stretching or the like, the control device 23 determines that the rider J is not in the normal driving posture. In this case as well, the control device 23 suppresses the disturbance of the posture of the rider J by taking measures such as lowering the output of the automatic control. The direction of the grasping loads may be set with a vertical downward direction as a reference direction, but it may also be set by learning the direction of the grasping loads during normal traveling without automatic control.

In a case in which it is detected that the rider J is in a non-normal driving posture, a warning may be given to the rider J by operating a warning means 49 which will be described later. Further, when it is detected that the rider J is in the non-normal driving posture, operations related to acceleration of the motorcycle 1 such as a throttle opening operation and a shift-up operation (operations that hinder deceleration) may be disabled or invalidated. In this case, as in the warning to the rider J, the rider J may be notified through his/her visual sense, auditory sense, tactile sense, or the like.

Returning to FIGS. 4 and 5, the external detection camera 38 captures a situation in front of the vehicle. The external detection camera 38 is provided, for example, at the front end portion of the vehicle body (for example, the front end portion of the front cowl 15). The image captured by the external detection camera 38 is transmitted to, for example, the control device 23, is subjected to appropriate image processing, and becomes desired image data to be used for various controls. That is, the information from the external detection camera 38 is used for recognizing the position, type, speed, and the like of the object in a detection direction, and based on this recognition, driving assist control, automatic driving control, and the like of the vehicle are performed.

For example, the external detection camera 38 may be a camera that captures not only visible light but also invisible light such as infrared rays. As an external detection sensor instead of the external detection camera 38, not only an optical sensor such as a camera but also a radio wave sensor such as a radar using infrared rays or microwaves such as millimeter waves may be used. A configuration including a plurality of sensors such as a stereo camera may be used instead of a single sensor. A camera and a radar may be used together.

The occupant detection camera 39 is, for example, a digital camera that uses a solid-state image sensor such as a CCD or CMOS, like the external detection camera 38. The occupant detection camera 39 is provided, for example, inside the front cowl 15 or above the rear cowl 19. The occupant detection camera 39 periodically and repeatedly images the head and upper body of the rider J, for example. The image captured by the occupant detection camera 39 is transmitted to, for example, the control device 23 and is used for the driving assist control, the automatic driving control, and the like of the vehicle.

The motorcycle 1 includes a steering actuator 43, a steering damper 44, and a warning means 49 in addition to an engine control means 45 and a brake actuator 42. The engine control means 45 includes a fuel injection device 46, an ignition device 47, a throttle device 48, and the like. That is, the engine control means 45 includes an auxiliary device for driving the engine 10. In the drawing, reference sign EN indicates a drive device configured to include the engine 10 and the auxiliary device.

The brake actuator 42 supplies hydraulic pressure to the front wheel brake main body 2B and the rear wheel brake main body 7B according to an operation on the brake operator ba to operate them. The brake actuator 42 also serves as a control unit for CBS and ABS.

The steering actuator 43 outputs steering torque to the steering shaft 4c. The steering actuator 43 operates an electric motor according to the detection information from the steering torque sensor 36 and applies assist torque to the steering shaft 4c.

The steering damper 44 is disposed near the head pipe 6, for example, and applies a damping force in a steering direction (a rotational direction around the steering shaft 4c) to a steering system including the handlebar 20. The steering damper 44 is, for example, an electronically controlled damper having a variable damping force, and its operation is controlled by the control device 23. The steering damper 44 reduces the damping force applied to the steering system when the motorcycle 1 is stopped or is at a low vehicle speed and increases the damping force applied to the steering system when the motorcycle 1 is at a medium or high vehicle speed. The steering damper 44 may be either a vane type or a rod type as long as the damping force is variable under the control of the control device 23.

The warning means 49 warns the rider J, for example, when it is determined that the rider J is not in a specified riding posture. The warning means 49 gives a warning through a visual sense, an auditory sense, or a tactile sense of the rider J. For example, the warning means 49 includes an indicator lamp, a display device, a speaker, a vibrator, and the like. The indicator lamp and the display device are disposed, for example, in the meter device 17. The speaker is installed in a helmet, for example and is wirelessly or wiredly connected to an audio signal output unit provided in the control device 23. The vibrator is disposed at a portion with which the body of the rider J in the specified riding posture comes into contact, for example, the seat 14, knee grip positions (the fuel tank 13, the side cover 18, and the like), the grips 20a, the step 14s, and the like.

### <Driving Support Device>

Next, an example of the driving support device of the motorcycle 1 of the present embodiment will be described.

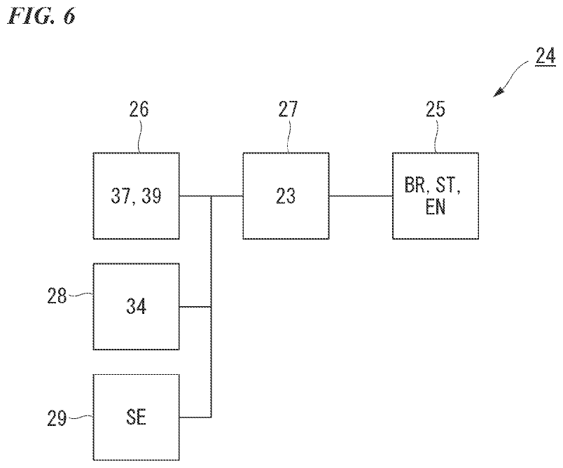

As shown in FIG. 6, a driving support device 24 of the present embodiment includes a vehicle body behavior generation means 25 that generates a behavior in a vehicle body with a specified output, a riding posture detection means 26 that detects the riding posture of the rider J, a vehicle body behavior detection means 28 that detects a roll angle from an upright state of the vehicle body, an external detection means 29 that detects a situation around the vehicle, and a control means 27 that controls drive of the vehicle body behavior generation means 25 based on detection information from the riding posture detection means 26, the vehicle body behavior detection means 28, and the external detection means 29.

The vehicle body behavior generation means 25 includes, for example, the brake device BR, the steering device ST, and the drive device EN.

The brake device BR includes the front and rear brake main bodies 2B and 7B and the brake actuator 42. The brake device BR is operated by at least one of the operation of the brake operator ba and the control of the control means 27 to generate a specified braking force.

The steering device ST includes the steering mechanism 4S and the steering actuator 43. The steering device ST is operated by at least one of the operation of the steering operator and the control of the control means 27 to generate a specified steering force.

The drive device EN includes an engine auxiliary device such as a throttle device 48. The engine auxiliary device is operated by at least one of the operation of the accelerator operator and the control of the control means 27 to generate a specified drive force in the engine 10.

The riding posture detection means 26 includes, for example, the riding sensor 37 and the occupant detection camera 39.

The riding sensor 37 includes the grip sensors 20c, the step sensors 14c, and the seat sensor 14d.

The occupant detection camera 39 detects, for example, the movement (movement amount) of the head and upper body of the rider J. The occupant detection camera 39 may detect the body movement of the rear passenger in addition to the body movement of the rider J.

The vehicle body behavior detection means 28 includes, for example, the vehicle body acceleration sensor (IMU) 34. In particular, the IMU 34 detects the angle (or the angular speed) and the acceleration of each of the roll axis, the pitch axis, and the yaw axis of the vehicle body, including the roll angle from the upright state of the vehicle body.

The control means 27 is, for example, the control device 23. At least part of the control means 27 may be realized by software and hardware in cooperation.

The external detection means 29 includes, for example, the external detection sensor SE constituted by various electromagnetic wave sensors. The external detection sensor SE includes the external detection camera 38 that captures an image in front of the vehicle and also includes a sensor and a camera that detect an object such as a vehicle present sideward and rearward of the own vehicle. The external detection means 29 may include map information of a navigation system and the like in addition to the external detection sensor SE.

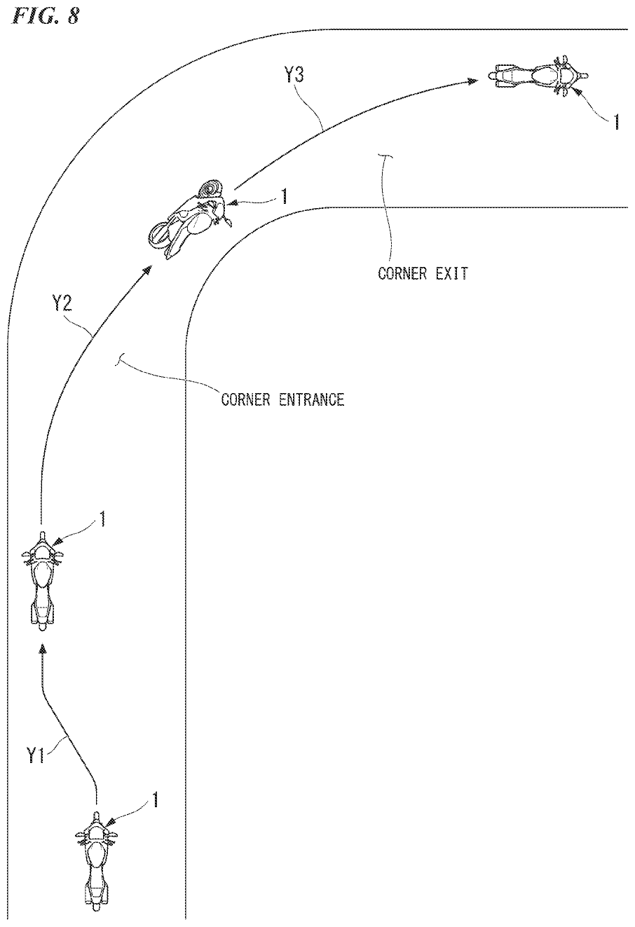

FIG. 8 is an explanatory view showing an example of driving support control.

The driving support control shown in FIG. 8 is a control for cornering in a case in which only a driving support device such as an adaptive cruise control system (ACC) or a lane keeping assistance system (LKAS) is operating. The control device 23 recognizes curving in the traveling lane and supports cornering based on, for example, information in front of the vehicle captured by the external detection camera 38.

The control device 23 controls each portion of the vehicle such that the own vehicle travels in the center in a lane width direction in the driving support during normal traveling (when the traveling corresponds to a straight line traveling in which the curvature of the lane is less than a predetermined threshold value).

When the external detection means 29 detects a corner in the traveling direction of the own vehicle, the control device 23 controls a traveling trajectory of the own vehicle by operating, for example, the steering device ST within a range that does not interfere with the operation of the rider J. At this time, the control device 23 changes the traveling trajectory to the outside of the corner (an outer side) in the lane width direction in the lane in which the own vehicle is traveling before reaching a corner entrance (see arrow Y1 in the drawing). By changing the traveling trajectory to the outer side when the motorcycle 1 enters the corner, the visibility of the corner is facilitated and driving fatigue is reduced. In addition, cornering with changes using the lane width is produced.

When the control device 23 detects the entering of the own vehicle to the corner by the external detection means 29 (and the vehicle body behavior detection means 28), the control device 23 returns the traveling trajectory to a lane center side (a center side) by operating, for example, the steering device ST within a range that does not interfere with the operation of the rider J (see arrow Y2 in the drawing). By changing the traveling trajectory from the outer side to the center side during cornering of the motorcycle 1, cornering with a margin at a distance from the road section on the outside of the corner is realized. In addition, cornering with changes using the lane width is further produced.

When the external detection means 29 detects a corner exit in the traveling direction of the own vehicle, the control device 23 changes again the traveling trajectory to the outside of the corner (the outer side) in the current traveling lane by operating, for example, at least one of the steering device ST and the drive device EN within a range that does not interfere with the operation of the rider J (see arrow Y3 in the drawing). By changing the traveling trajectory to the outer side at the corner exit of the motorcycle 1, it becomes easier to accelerate at the corner exit. In addition, cornering with changes (out-in-out) using the lane width is further produced.

The control device 23 can change the traveling trajectory within the width of the current traveling lane according to the situation around the vehicle detected by the external detection means 29, not only at the time of cornering.

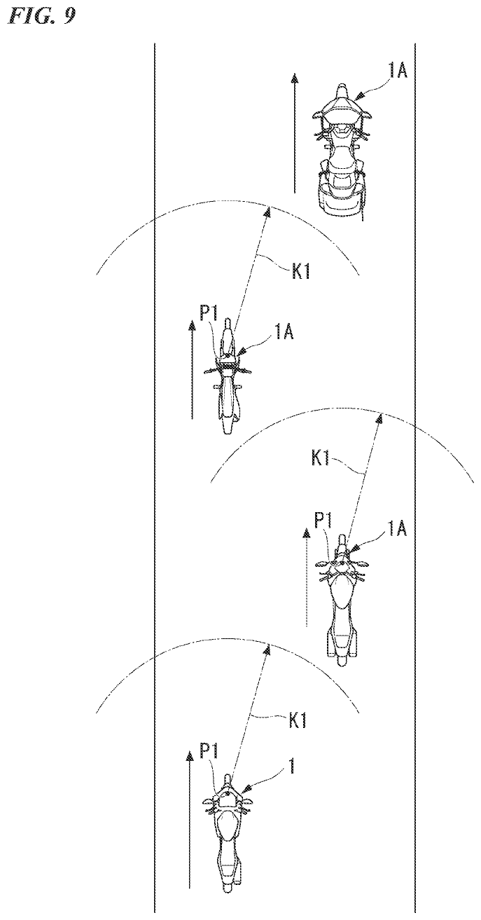

The driving support control shown in FIG. 9 shows an example of a control mode during group traveling including the own vehicle. In this control mode, a plurality of motorcycles 1 arranged in the front-rear direction are arranged in a state of being alternately shifted in the lane width direction (in other words, in a state arranged in a so-called zigzag shape). The control device 23 has a control mode in which a plurality of vehicles are arranged in a zigzag shape as described above in the driving support control, and this mode can be appropriately selected by a switching operation of the rider J or the like. The control device 23 measures, for example, a distance from a reference position P1 such as the center of a lens of the external detection sensor SE to the detection target (a preceding vehicle 1A). As described above, when a plurality of vehicles perform traveling in a zigzag shape (zigzag traveling), the control device 23 maintains the inter-vehicle distance to the preceding vehicle 1A constant in a direction facing the preceding vehicle 1A located diagonally forward with respect to the vehicle front-rear direction.

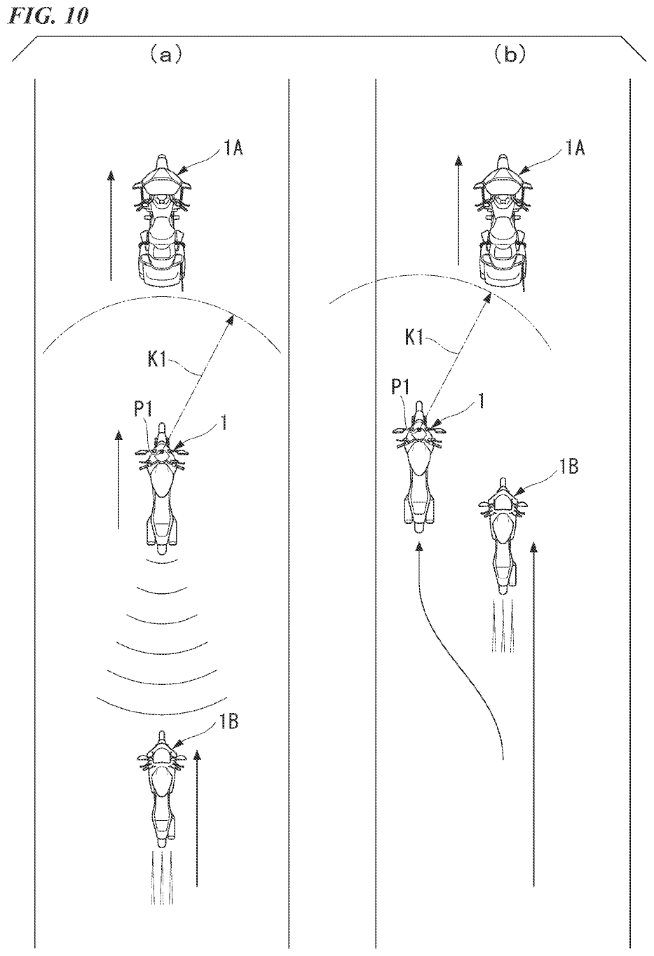

The driving support control shown in FIG. 10 is a control for urging a following vehicle 1B to pass. FIG. 10(a) shows, for example, a case in which the following vehicle 1B approaches from the rearward of the vehicle at a speed equal to or higher than a specified relative speed when the motorcycle 1 performs the normal traveling with driving support control to follow the preceding vehicle 1A. At this time, as shown in FIG. 10(b), the motorcycle 1 changes the traveling trajectory of its own vehicle to the shoulder side (the left side) with intervention control by the control device 23. As a result, the following vehicle 1B approached the motorcycle 1 can pass the own vehicle without changing lanes.

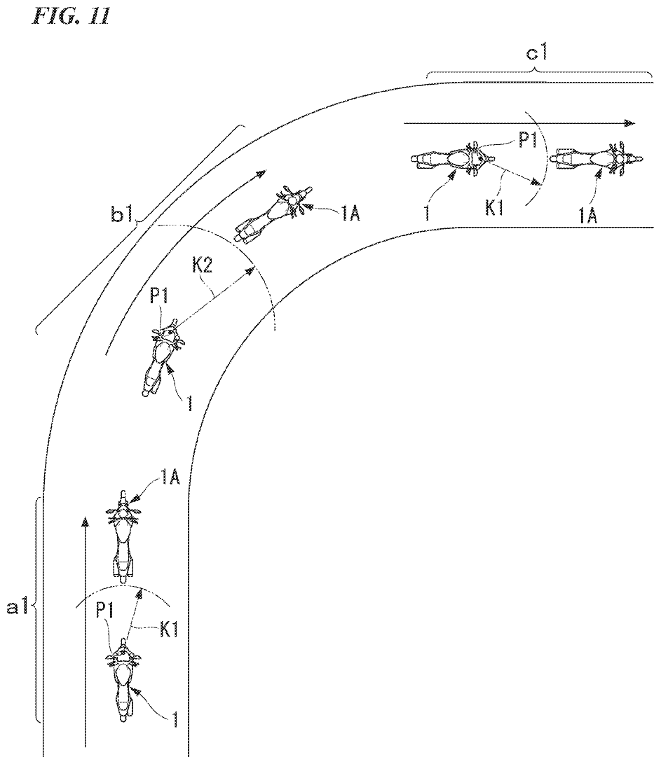

The driving support control shown in FIG. 11 shows an example of control for changing the inter-vehicle distance to the preceding vehicle 1A when the motorcycle 1 performs cornering while following the preceding vehicle 1A. In this example, the control device 23 performs the following control when the external detection sensor SE detects a corner in the traveling direction of the own vehicle. In this control, at least one of the brake device BR and the drive device EN is operated to change the relative speed with respect to the preceding vehicle 1A. As a result, the motorcycle 1 perform cornering (a range b1 in the drawing) to follow the preceding vehicle 1A with a second inter-vehicle distance K2, which is wider than the inter-vehicle distance (a first inter-vehicle distance K1) during normal traveling (a range al in the drawing).

The motorcycle 1 increases the inter-vehicle distance with respect to the preceding vehicle 1A to follow as the external detection sensor SE detects a corner in front of the vehicle. As a result, the occurrence of acceleration/deceleration during cornering is suppressed. The acceleration/deceleration during turning (when the vehicle body is banked) of the motorcycle 1 causes the vehicle body behavior not only in the pitching direction but also in the rolling direction, and thus effort is required to control the vehicle body behavior. On the other hand, by suppressing the occurrence of the acceleration/deceleration during cornering, fatigue during driving support control is reduced.

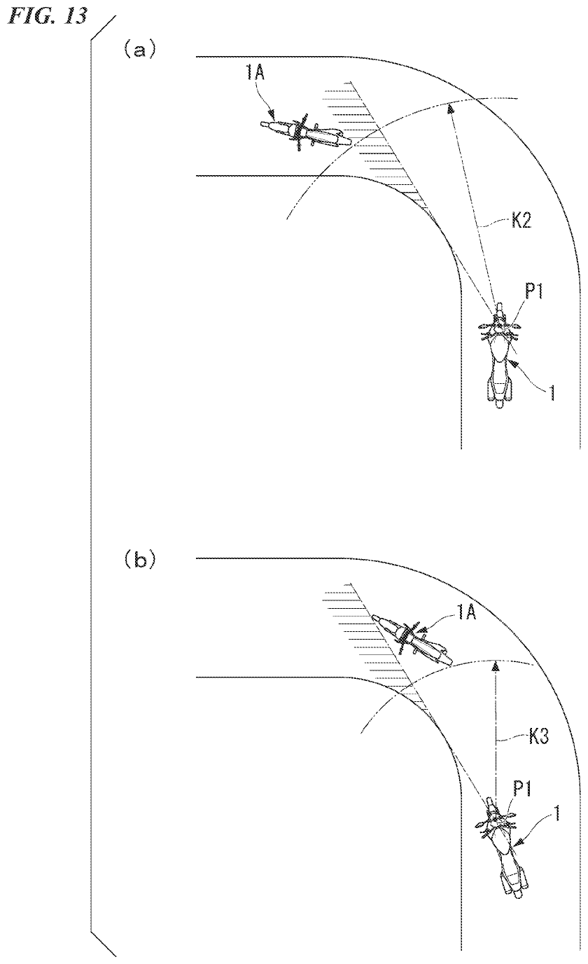

The control device 23 maintains the second inter-vehicle distance K2 during cornering in following traveling of the motorcycle 1. However, as shown in FIG. 13, in a blind corner where visibility is not effective, such as a corner on a mountain side (a left side) on a mountain road, the external detection sensor SE may lose sight of the preceding vehicle 1A when the inter-vehicle distance increases. When the external detection sensor SE loses sight of the preceding vehicle 1A during cornering, the control device 23 controls to reduce the inter-vehicle distance to a distance allowing to detect the preceding vehicle 1A (shown as K3 in the drawing) by operating at least one of the brake device BR and the drive device EN. This enables stable driving support control without interrupting the following traveling during cornering.

Returning to FIG. 11, the control device 23 performs the following control when the external detection sensor SE detects the corner exit in the traveling direction of the own vehicle. In this control, at least one of the brake device BR and the drive device EN is operated to change the relative speed with respect to the preceding vehicle 1A. As a result, the motorcycle 1 reduces the second inter-vehicle distance K2 and returns it to the first inter-vehicle distance K1 during the normal traveling (a range cl in the drawing). As a result, after cornering, it is possible to quickly return to the following traveling state before cornering.

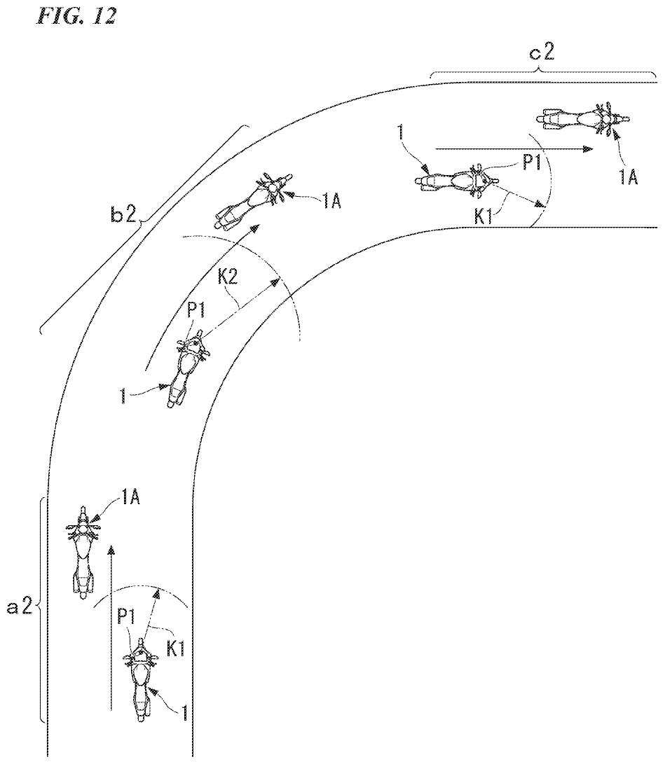

As shown in FIG. 12, even when the control device 23 is executing the control mode in which the zigzag traveling is performed by a plurality of vehicles (only two are shown in FIG. 12), as described above, the control device 23 performs control to allow the own vehicle to perform cornering while adjusting the inter-vehicle distance to the preceding vehicle 1A. At this time, the inter-vehicle distance to the preceding vehicle 1A is measured in an inclined direction (a direction toward the preceding vehicle 1A arranged in a zigzag shape) diagonally forward with respect to the traveling trajectory following the curve of the corner. As a result, it becomes possible for a plurality of vehicles to perform cornering while maintaining the inter-vehicle distance while traveling in a zigzag shape. In the drawing, a range a2 indicates the range of the inter-vehicle distance K1 before cornering, reference sign b2 indicates the range of the inter-vehicle distance K2 during cornering, and the reference sign c2 indicates the range of the inter-vehicle distance K3 after cornering.

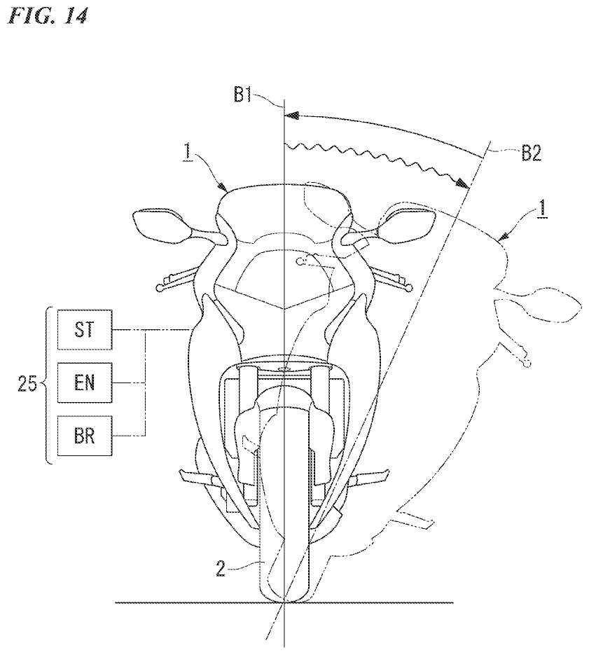

As shown in FIG. 14, the control device 23 performs the following control when the vehicle body behavior generation means 25 is operated to bank the vehicle body, at the time of driving support of the own vehicle. In this control, when the vehicle body is changed from the upright state B1 to the banked state B2, a speed of increase in the roll angle detected by the vehicle body behavior detection means 28 is controlled to be less than a predetermined roll speed threshold value. This makes the bank of the vehicle body gentle and improves controllability.

On the other hand, the control device 23 performs the following control when the vehicle body behavior generation means 25 is operated to return the vehicle body to the upright state. In this control, when the vehicle body is returned from the banked state B2 to the upright state B1, the control in which the vehicle body is raised and the vehicle speed is increased without restricting a speed of increase in the roll angle detected by the vehicle body behavior detection means 28 is performed. As a result, the vehicle body is quickly brought closer to the upright state, and the effort of the rider J is reduced.

In addition, the control device 23 may intervene a drive force due to the operation of the drive device EN during the cornering in which the vehicle body is banked, at the time of driving support of the own vehicle. At this time, a so-called rear steering enhances a turning force and smooths corner escape. Further, the action to raise the vehicle body from the banked state is generated, the vehicle body is brought closer to the upright state, and the fatigue of the rider J is reduced.

The control device 23 may combine the drive device EN and the brake device BR to cause the vehicle body to be raised from a banked state during cornering in which the vehicle body is banked, at the time of driving support of the own vehicle.

For example, under a constant vehicle speed, if a movement that increases the angular speed on the side where the vehicle body is raised from the banked state and decreases the acceleration on the side where the vehicle body is made to be the banked state is continuously performed, it is expected that the traveling trajectory is easily to be biased to the outside of the corner. Therefore, by combining brake control therewith to return the traveling trajectory inside the corner, it is possible to easily maintain the assumed traveling trajectory.

In the cornering of the motorcycle 1, the drive force of the engine is reduced when entering the corner, and the drive force of the engine 10 is used to stabilize a turning movement during turning in many cases. On the other hand, in the following traveling to the preceding vehicle 1A, when the vehicle turns at a constant vehicle speed, the rider J may feel a sense of discomfort, which may affect the attractiveness of the product.

Therefore, by automatically controlling the drive force of the engine 10 as described above within a range that does not affect the vehicle speed, the rider J realizes a comfortable maneuvering performance and improves the attractiveness of the product.

The above-described driving support control enables the cornering of the motorcycle 1 without the operation by the rider J, but it is possible to prioritize the operation intention of the rider J and to cause the operation by the rider J to intervene in the driving support control even during the control.

Here, the motorcycle 1 generates a steering assist force around the steering shaft 4c by the drive of the steering actuator 43. The strength of this assist force is such that it does not interfere with the steering operation of the rider J.

For example, when the motorcycle 1 is traveling in an upright state and a clockwise steering assist force is generated at the center of the steering shaft 4c, the following actions occur. That is, in the motorcycle 1, an action (a roll assist force) to roll the vehicle body to the left side (the side opposite to the steering direction) occurs. In other words, the reverse steering acts to bank the vehicle body.

After that, as a bank angle increases, the reverse steering disappears, and the vehicle becomes a self-steering state in which the front wheel 2 has a steering angle toward the bank side. Then, when the bank angle and the steering angle reach a predetermined angle according to the vehicle speed and the like, the turning traveling in which the bank angle and the steering angle are kept is started.

For example, when the motorcycle 1 rolls (banks) the vehicle body to the left side and is in the turning traveling, if a counterclockwise (the same side as a roll direction) steering assist force is generated at the center of the steering shaft 4c, the following actions occur. That is, in the motorcycle 1, an action to raise the vehicle body to the right side (the side opposite to the steering direction) occurs. In other words, the additional steering of the steering mechanism 4S causes an action to return the vehicle body to the upright state.

The control means 27 controls the drive of the steering actuator 43 such that when the motorcycle 1 is banked (when the bank angle is increased), the speed of increase (the increase rate) in the bank angle (the roll angle) becomes less than a predetermined threshold value. By restricting the speed of increase in the bank angle, the motorcycle 1 can be tilted gently, and it is easy to control the vehicle body.

The control means 27 makes it easy to return the vehicle body to the upright state without restricting the speed of decrease in the bank angle when the motorcycle 1 is raised from the banked state (when the bank angle is decreased). As a result, the behavior of the vehicle body is suppressed with respect to the banked state of the vehicle body, and it is possible to quickly shift to acceleration at the end of cornering or the like.

The acceleration/deceleration during cornering causes behavior in a pitch direction, and the adjustment of the vehicle body bank angle causes behavior in a roll direction. Therefore, the effort of the rider J required to control the vehicle body is larger than that when traveling in a straight line. On the other hand, the control device 23 assists the acceleration/deceleration and the adjustment of the bank angle during cornering to reduce the fatigue of the rider J.

As described above, the driving support device 24 of a saddle-riding type vehicle according to the above embodiment includes the external detection means 29 that detects a situation around the vehicle, the steering device ST that steers the own vehicle, and the control means 27 that controls drive of the steering device ST, and the control means 27 operates the steering device ST according to the situation around the vehicle detected by the external detection means 29 regardless of the operation of the rider J and moves the traveling trajectory in the lane width direction within the lane in which the own vehicle is traveling.

According to this configuration, when driving support control such as the following traveling control or the lane maintaining support is performed, it is possible to change the position of the own vehicle in the lane width direction within the same traveling lane according to the situation around the vehicle detected by the external detection means 29. For this reason, in driving support control, for example, it is possible to change the traveling trajectory to the inside or outside of the corner within the same lane during cornering, or to arrange the vehicles in a zigzag shape by alternately shifting the vehicles in the lane width direction during group driving, and thus it is possible to enhance the commercial value of the driving support device 24.

In the driving support device 24 of a saddle-riding type vehicle, when the external detection means 29 detects a corner in the traveling direction of the own vehicle, the control means 27 operates the steering device ST and moves the traveling trajectory to the outside of the corner within the lane in which the own vehicle is traveling.

According to this configuration, it is possible to change the traveling trajectory of the own vehicle to the outside of the corner within the same traveling lane according to the corner in front of the vehicle detected by the external detection means 29. As a result, it is possible to assist the own vehicle to be located on the outer side when entering the corner, to improve the visibility of the corner, to reduce the fatigue of the driver, and to produce cornering using the lane width.

In the driving support device 24 of a saddle-riding type vehicle, when the external detection means 29 detects the entering of the own vehicle to the corner, the control means 27 operates the steering device ST and moves the traveling trajectory toward the center in the lane width direction within the lane in which the own vehicle is traveling.

According to this configuration, it is possible to move the traveling trajectory from the outside of the corner to the center side of the lane width during the cornering of the own vehicle. As a result, after the own vehicle enters the corner from the outer side, the traveling trajectory is moved to the inside of the corner (the center side), and it is possible to produce cornering using the lane width.

In the driving support device 24 of a saddle-riding type vehicle, when the external detection means 29 detects a corner exit in the traveling direction of the own vehicle, the control means 27 operates the steering device ST and moves the traveling trajectory to the outside of the corner within the lane in which the own vehicle is traveling.

According to this configuration, when the own vehicle reaches the corner exit, it is possible to move the traveling trajectory from the center side of the lane width to the outside of the corner. Therefore, it is possible to produce cornering in which the own vehicle is accelerated at the corner exit and is biased to the outer side.

In the driving support device 24 of a saddle-riding type vehicle, when the external detection means 29 detects the approach of the following vehicle 1B from the rearward of the vehicle, the control means 27 operates the steering device ST and moves the traveling trajectory to the shoulder side within the lane in which the own vehicle is traveling.

According to this configuration, when the approach of the following vehicle 1B is detected, the own vehicle is moved to the shoulder side within the traveling lane, and thus the own vehicle is easily passed by the approached following vehicle 1B. As a result, it is possible to enhance the commercial value of the driving support device 24.

In the driving support device 24 of a saddle-riding type vehicle, the control means 27 has a control mode in which the traveling trajectory is shifted with respect to the preceding vehicle 1A in the lane width direction within the lane in which the own vehicle is traveling when the following traveling is performed while maintaining an inter-vehicle distance with respect to the preceding vehicle 1A.

According to this configuration, when the following traveling is performed with respect to the preceding vehicle 1A, it is possible not only to perform the following traveling at a position directly behind the preceding vehicle 1A but also to perform the following traveling at a position shifted with respect to the preceding vehicle 1A in the lane width direction. Therefore, for example, when a plurality of vehicles are traveling in a group, it is possible to assist so-called the zigzag traveling in which the vehicles are alternately shifted and arranged in the lane width direction, and thus it is possible to enhance the commercial value of the driving support device 24.

Further, the driving support device 24 of the saddle-riding type vehicle includes the external detection means 29 that detects the situation around the vehicle, the brake device BR that brakes the own vehicle, the drive device EN that drives the own vehicle, and the control means 27 that controls drive of the brake device BR and the drive device EN, the control means 27 performs the following traveling control in which the own vehicle follows the preceding vehicle 1A while maintaining the first inter-vehicle distance K1 by operating at least one of the brake device BR and the drive device EN, and when the following traveling control is performed and the external detection means 29 detects a corner in the traveling direction of the own vehicle, the control means 27 sets the inter-vehicle distance with respect to the preceding vehicle 1A to second inter-vehicle distance K2, which is longer than the first inter-vehicle distance K1, by adjusting the operation of at least one of the brake device BR and the drive device EN.

According to this configuration, at the time of the following traveling control, the inter-vehicle distance with respect to the preceding vehicle 1A is increased as the external detection means 29 detects the corner in front of the vehicle. As a result, it is possible to suppress the occurrence of the acceleration/deceleration during cornering. The acceleration/deceleration during cornering (when the vehicle body is banked) of the saddle-riding type vehicle causes not only the vehicle body behavior in the pitching direction but also the vehicle body behavior in the rolling direction, and thus effort is required to control the vehicle body behavior. On the other hand, by suppressing the occurrence of the acceleration/deceleration during cornering, it is possible to reduce the fatigue of the rider J.

In the driving support device 24 of a saddle-riding type vehicle, the control means 27 maintains the second inter-vehicle distance K2 during cornering at the time of the following traveling control.

According to this configuration, during cornering in the following traveling control, the inter-vehicle distance with respect to the preceding vehicle 1A is maintained in an increased state. As a result, it is possible to allow a margin for the acceleration/deceleration during cornering and reduce the fatigue of the rider J.

In the driving support device 24 of a saddle-riding type vehicle, when the external detection means 29 loses sight of the preceding vehicle 1A during cornering at the time of the following traveling control, the control means 27 reduces the inter-vehicle distance until the preceding vehicle 1A is detected by adjusting the operation of at least one of the brake device BR and the drive device EN.

According to this configuration, in a case in which the preceding vehicle 1A is lost by increasing the inter-vehicle distance with respect to the preceding vehicle 1A during cornering such as a blind corner with poor visibility at the time of the following traveling control, control is performed to reduce the inter-vehicle distance until the preceding vehicle 1A is detected. As a result, it is possible to perform stable driving support control without interrupting the following traveling during cornering.

In the driving support device 24 of a saddle-riding type vehicle, when the external detection means 29 detects the corner exit in the traveling direction of the own vehicle during cornering at the time of the following traveling control, the control means 27 returns the inter-vehicle distance with respect to the preceding vehicle 1A to the inter-vehicle distance K1 by adjusting the operation of at least one of the brake device BR and the drive device EN.

According to this configuration, at the time of following traveling control, at the corner exit, the inter-vehicle distance with respect to the preceding vehicle 1A is returned to the first inter-vehicle distance K1 before cornering, and thus, after the cornering is completed, it is possible to quickly return the state of the own vehicle to the following traveling state before cornering.

In the driving support device 24 of a saddle-riding type vehicle, the control means 27 has the control mode in which at the time of the following traveling control, the traveling trajectory is shifted with respect to the preceding vehicle 1A in the lane width direction within the lane in which the own vehicle is traveling, and when cornering is performed in this control mode, the control means 27 adjusts the inter-vehicle distance to the preceding vehicle 1A shifted in the lane width direction.

Therefore, for example, when a plurality of vehicles are traveling in a group, it is possible to assist so-called the zigzag traveling in which the vehicles are alternately shifted and arranged in the lane width direction, and thus it is possible to perform cornering while maintaining the zigzag traveling. Therefore, it is possible to enhance the commercial value of the driving support device 24.

Further, the driving support device 24 of a saddle-riding type vehicle includes the vehicle body behavior generation means 25 that generates the behavior including a roll motion in the vehicle body with a specified output, the control means 27 that controls drive of the vehicle body behavior generation means 25, and the vehicle body behavior detection means 28 that detects the behavior of the vehicle body, the control means 27 controls a speed of increase in a bank angle detected by the vehicle body behavior detection means 28 to be less than a predetermined roll speed threshold value when the control means 27 operates the vehicle body behavior generation means 25 and banks the vehicle body, at the time of driving support of an own vehicle, and the control means 27 raises the vehicle body without restricting a speed of decrease in the bank angle detected by the vehicle body behavior detection means 28 when the control means 27 operates the vehicle body behavior generation means 25 and raises the vehicle body from a banked state, at the time of driving support of the own vehicle.

According to this configuration, when the vehicle body is banked at the time of driving support of the own vehicle, the bank of the vehicle body can be made gentle and the controllability can be improved by setting an upper limit on the speed of increase in the bank angle. On the other hand, when the vehicle body is raised from the banked state, by raising the vehicle body without restricting the speed of decrease in the bank angle, it is possible to quickly bring the vehicle body closer to the upright state and to reduce the effort of the rider J.

The driving support device 24 of a saddle-riding type vehicle further includes a steering device ST that steers the own vehicle, and the control means 27 operates the steering device ST and raises the own vehicle from a banked state at the time of deceleration during cornering in which the vehicle body is banked, at the time of driving support of the own vehicle.

According to this configuration, the steering device ST is operated at the time of deceleration during cornering of the own vehicle to bring the vehicle body closer to the upright state, and thus it is possible to reduce the fatigue of the rider J. Normally, the acceleration/deceleration in the vehicle body bank tends to cause vehicle body behavior in the roll direction in addition to the pitch direction, and thus the effect of automatically controlling the acceleration/deceleration is high.

The driving support device 24 of a saddle-riding type vehicle further includes the drive device EN that drives the own vehicle, and the control means 27 operates the drive device EN and raises the vehicle body from a banked state during cornering in which the vehicle body is banked, at the time of driving support of the own vehicle. According to this configuration, a so-called rear steering is intervened by operating the drive device EN to generate a drive force during cornering of the own vehicle. Therefore, it is possible to reduce the bank angle of the vehicle body and to improve the turning performance, and it is possible to reduce the fatigue of the rider J.

The present invention is not limited to the above-described embodiment, and for example, the saddle-riding type vehicle includes all vehicles in which a driver straddles the vehicle body, including a motorcycle (including a motorized bicycle or a scooter type vehicle) as well as a three-wheeled vehicle (including a vehicle having one front wheel and two rear wheels as well as a vehicle having two front wheels and one rear wheel) or a four-wheeled vehicle.

The configuration in the above-described embodiment is an example of the present invention, and various changes can be made without departing from the scope of the present invention, such as replacing the components of the embodiment with the known components.

### BRIEF DESCRIPTION OF THE REFERENCE SYMBOLS

1: Motorcycle (saddle-riding type vehicle)

1A: Preceding vehicle

1B: Following vehicle

10: Engine

23: Control device

24: Driving support device

25: Vehicle body behavior generation means

27: Control means

28: Occupant behavior detection means

29: External detection means

38: External detection camera

BR: Brake device

EN: Drive device

ST: Steering device

SE: External detection sensor

J: Rider

K1, K2: Inter-vehicle distance

What is claim is:

1. A driving support device of a saddle-riding type vehicle comprising:
an external detection means that detects a situation around the vehicle;
a steering device that steers an own vehicle; and
a control means that controls drive of the steering device,
wherein the control means operates the steering device according to the situation around the vehicle detected by the external detection means regardless of an operation of a rider and moves a traveling trajectory in a lane width direction within a lane in which the own vehicle is traveling.

2. The driving support device of a saddle-riding type vehicle according to claim 1, wherein, when the external detection means detects a corner in a traveling direction of the own vehicle, the control means operates the steering device and moves the traveling trajectory to an outside of the corner within the lane in which the own vehicle is traveling.

3. The driving support device of a saddle-riding type vehicle according to claim 1, wherein, when the external detection means detects that the own vehicle enters a corner, the control means operates the steering device and moves the traveling trajectory toward a center in the lane width direction within the lane in which the own vehicle is traveling.

4. The driving support device of a saddle-riding type vehicle according to claim 1, wherein, when the external detection means detects a corner exit in a traveling direction of the own vehicle, the control means operates the steering device and moves the traveling trajectory to an outside of the corner within the lane in which the own vehicle is traveling.

5. The driving support device of a saddle-riding type vehicle according to claim 1, wherein, when the external detection means detects approach of a following vehicle from behind the vehicle, the control means operates the steering device and moves the traveling trajectory to a shoulder side within the lane in which the own vehicle is traveling.

6. The driving support device of a saddle-riding type vehicle according to claim 1, wherein the control means has a control mode in which, when following traveling is performed while maintaining an inter-vehicle distance with a preceding vehicle, the traveling trajectory is shifted with respect to the preceding vehicle in the lane width direction within the lane in which the own vehicle is traveling.
